(19) United States
(12) Patent Application Publication
(10) Pub. No.: US 2024/0005281 A1
(43) Pub. Date: Jan. 4, 2024

(54) HIERARCHICAL PROJECT MANAGEMENT APPARATUS

(71) Applicants: DELTA PDS CO., LTD., Seoul (KR); Jae Ho CHOI, Seoul (KR)

(72) Inventor: Jae Ho CHOI, Seoul (KR)

(73) Assignees: DELTA PDS CO., LTD., Seoul (KR); Jae Ho CHOI, Seoul (KR)

(21) Appl. No.: 18/226,558

(22) Filed: Jul. 26, 2023

Related U.S. Application Data
(63) Continuation of application No. 15/664,412, filed on Jul. 31, 2017, now abandoned.

(30) Foreign Application Priority Data
Jul. 29, 2016 (KR) 10-2016-0097266
Jun. 21, 2017 (KR) 10-2017-0078311
Jul. 7, 2017 (KR) 10-2017-0086249

(51) Int. Cl. G06Q 10/10; G06F 16/22; H04L 67/60; H04L 67/10

(52) U.S. Cl. CPC G06Q 10/103; H04L 67/10; H04L 67/60; G06F 16/2246

(57) ABSTRACT

A hierarchical project management apparatus includes a memory and a processor electrically connected to the memory. The processor creates a project chatroom associated with a project, creates at least one of a note object, a multimedia file object, and an attachment file associated with a work of the project in the project chatroom, and creates a work object associated with the note object, the multimedia file object, or the attachment file, and including a work creator, a work processor, and a work progress state representing a progress state for each work processing step.

### CROSS-REFERENCE TO RELATED APPLICATIONS

This Application is a Continuation Application of U.S. patent application Ser. No. 15/664,412 (filed on Jul. 31, 2017), which claims priority to Korean Patent Application Nos. 10-2016-0097266 (filed on Jul. 29, 2016), 10-2017-0078311 (filed on Jun. 21, 2017), and 10-2017-0086249 (filed on Jul. 7, 2017), which are all hereby incorporated by reference in their entirety.

### BACKGROUND

The present invention disclosed herein relates to a work evaluation inquiry technology, and more particularly, to a hierarchical project management apparatus capable of enhancing project management efficiency through hierarchical macro and micro management processes.

An Internet messenger corresponds to an application for delivering a message including characters or graphics between users, and can be implemented with a chat room participated by a plurality of users. In one embodiment, the Internet messenger may include a mobile messenger that is performed in a mobile environment (e.g., a mobile phone), and may include, for example, Kakao chat, Line, Wichat, Facebook messenger.

As the number of users using the Internet messenger is rapidly increasing, applications used in the mobile environment are being developed in various ways. Among applications, the project management program is used by many users.

Korean Patent Publication No. 10-2005-0092173 relates to a data input method and a screen display method for processing work in a mobile device, which discloses a technology of displaying a date or a to-do list in a row or a column in a table form; when a date is selected, displaying tasks corresponding to the date in a box form, and setting the left and right end boxes of the box as the start date and end date of the corresponding tasks, and when the start date and end date boxes are not displayed on the screen, displaying information on the start date and the end date in the left and right end boxes displayed on the screen, respectively; displaying information on the tasks in the box; and outputting a selection window including completion of tasks, postponement of tasks, end of tasks, and progress of tasks, such that a user can manipulate the contents stored by date in regard to the tasks.

Korean Patent Registration No. 10-0663494 relates to a task management method using a mobile communication terminal, which discloses a technology of determining whether or not a predetermined time is reached, checking unfinished tasks among pre-registered tasks when a predetermined time is reached, and displaying the unfinished tasks according to the result of the check.

### PRIOR ART DOCUMENT

### Patent Document

Korean Patent Publication No. 10-2005-0092173 (published on Sep. 21, 2005)
Korean Patent No. 10-0663494 (registered on Dec. 22, 2006)

### SUMMARY

The present invention provides a hierarchical project management apparatus capable of improving project management efficiency through hierarchical macro and micro management processes which are hierarchically performed.

The present invention also provides a hierarchical project management apparatus that performs a project-oriented macro management process through a project message thread and a unit task-oriented micro management process through a task message thread to improve both the efficiency of the overall project and the efficiency of unit task management.

Embodiments of the present invention provide hierarchical project management apparatuses including: a memory storing a macro management block and a micro management block which have different work evaluation access rights; and a processor controlling a tree structure association between the macro management block and the micro management block, wherein the processor includes: performing a macro management process of generating a project and a project message thread associated with the project in the macro management block and associating a note object including a container of a work object as a unit work of the project with the project message thread; and performing a micro management process of generating a work message thread associated with the note object in the micro management block, associating the work object with the work message thread, and updating the tree structure by inserting the work object into the micro management block whenever the work object is generated.

In some embodiments, the performing of the macro management process may include granting a work performance access right for the macro and micro management blocks associated with the project to each of at least one user participating in the project message thread.

In some embodiments, the performing of the macro management process may include determining an importance of the project based on the number of note objects associated with the project message thread and providing information on the importance to a super manager.

In some embodiments, the performing of the macro management process may include providing a note object creation recommendation message that recommends the creation of a new note object associated with the project message thread through the project message thread when the number of generated note objects associated with the project message thread or the update frequency of the work message thread is smaller than or equal to a specific reference.

In some embodiments, the performing of the macro management process may include associating a schedule object having a schedule timeline defined through a start date and a finish date with the project message thread.

In some embodiments, the performing of the macro management process may include re-associating the tree structure between the macro management block and the micro management block when creation or deletion of the note object associated with the project message thread or associated with the schedule object occurs.

In some embodiments, the performing of the macro management process may include generating schedule achievement information analyzed in time series about the schedule object based on the start date and the finish date in the schedule timeline of the schedule object.

In some embodiments, the performing of the macro management process may include providing a schedule completion recommendation message that recommends the completion of the schedule object through the project message thread when the number of generated note objects associated with the schedule object or the update frequency of the work message thread is smaller than or equal to a specific reference and when a schedule target associated with the schedule object is larger than or equal to a specific percentage.

In some embodiments, the performing of the macro management process may include generating the note object by adding the note object to the project message thread as an independent note message that is directly accessible in the corresponding project message thread and distinguished from a text message or a media message.

In some embodiments, the performing of the macro management process may include evaluating the project through a work evaluation access right of a super manager.

In some embodiments, the performing of the macro management process may include: granting a qualitative project evaluation point of the project based on an evaluation received from a user terminal associated with the super manager; calculating a qualitative project evaluation point of the project based on the number of generated note objects associated with the corresponding project 310, and the number, the processing number and the processing period of work objects generated through the note object; and calculating a total evaluation point of the project based on the qualitative project evaluation point and the quantitative project evaluation point.

In some embodiments, the performing of the micro management process may include generating a work message thread between the work creator and the work processor associated with the corresponding note object and adding the work object to the work message thread as a work message when the work object including a work creator, a work processor and a work evaluation point and capable of being fed back by the work processor is generated.

In some embodiments, the performing of the micro management process may include performing the progress of the work object including a work progress state indicating a progress state for each process based on a feedback by the work processor and finally evaluating the work object through the work evaluation access right of the work creator.

In some embodiments, the performing of the micro management process may include updating the work progress state of the work object through a work object related response implemented with a response relationship between the work creator and the work processor.

In some embodiments, the performing of the micro management process may include providing a remind message associated with the work object through the work message thread associated with the note object and requesting the completion of the corresponding work progress state according to a specific repetition standard until the work progress state is completed.

In some embodiments, the performing of the micro management process may include calculating the work response speed based on the number of times of provision of the remind message and including the work response speed in the corresponding work evaluation point of the work object.

Other embodiments of the present invention provide computer readable recording media executable by a computer recorded with a computer program about a hierarchical project management method including: performing a macro management process of generating a project and a project message thread associated with the project in a macro management block and associating a note object including a container of a work object as a unit work of the project with the project message thread; and performing a micro management process of generating a work message thread associated with the note object in a micro management block, associating the work object with the work message thread, and updating the tree structure by inserting the work object into the micro management block whenever the work object is generated.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention.

FIG. 1 is a view illustrating a hierarchical project management system according to an embodiment of the present invention.

FIG. 2 is a view illustrating a hierarchical project management apparatus of FIG. 1.

FIG. 3 is a view illustrating a data structure of a memory in FIG. 2.

FIG. 4 is a view illustrating functional elements of a processor in FIG. 2.

FIG. 5 is a flowchart illustrating a hierarchical project management procedure performed by a processor in FIG. 2.

FIG. 6 is a view illustrating a process of providing hierarchical project management data by a hierarchical project management apparatus of FIG. 1 according to an embodiment of the present invention.

FIG. 7 is a view illustrating a process of performing a macro management process through a project message thread by a hierarchical project management apparatus in FIG. 1 according to an embodiment of the present invention.

FIG. 8 is a view illustrating a process of performing a micro management process through a work message thread by a hierarchical project management apparatus in FIG. 1 according to an embodiment of the present invention.

FIG. 9A-9E are views illustrating a process of performing analysis according to a user request by a hierarchical project management apparatus of FIG. 1 according to an embodiment of the present invention.

### DETAILED DESCRIPTION

Hereinafter, it will be described about an exemplary embodiment of the present invention in conjunction with the accompanying drawings.

The description of the present invention is merely an example for structural or functional description, and the scope of the present invention should not be construed as being limited by the embodiments described in this disclosure. That is, since the embodiments can be variously modified and have various forms, it should be understood that the scope of the present invention includes equivalents capable of realizing the technical spirit of the present invention. Also, since it is not meant to imply that a specific embodiment should include all of the objectives and effects proposed in this disclosure or include only those effects, it should be understood that the scope of the disclosed technology is not to be construed as being limited thereby.

Meanwhile, the meanings of the terms set forth herein should be understood as follows.

The terms “first”, “second”, and the like are used to distinguish one element from another, and the scope of the right should not be limited by these terms. For example, a first component may be named a second component, and similarly, the second component may be named the first component.

It should be understood that when an element is referred to as being “connected” or “coupled” to another element, it may be directly connected or coupled to the other element but another element may also be interposed therebetween. On the other hand, when an element is referred to as being “directly connected” or “directly coupled” to another element, it should be understood that there are no other elements in between. Meanwhile, other expressions that describe the relationship between components, such as “between” and “just between” or “adjacent to” and “directly adjacent to” should be interpreted as well.

It should be understood that the terms of a singular form may include plural forms unless referred to the contrary. In this disclosure, the terms “include,” “comprise,” or “have” specify features, numbers, steps, operations, elements or combinations thereof, but do not exclude existence or addition possibility of one or more other features, numbers, steps, operations, elements or combinations thereof.

In each step or operation, the identification characters (e.g., a, b, c, etc.) are used for convenience of description, and the identification characters do not describe the order of the steps or operations. The steps and operations may occur differently from the stated order unless explicitly stated in a specific order in the context. That is, each process may occur in the same order as described, and may be performed at the substantially same time or may be performed in the opposite order.

The computer readable medium may include all kinds of recording devices in which data that can be read by a computer system are stored. Examples of the computer-readable recording medium include ROM, RAM, CD-ROM, magnetic tape, floppy disk, optical data storage, and the like. Also, the computer-readable recording medium may be distributed over a networked computer system, so that computer readable code can be stored and executed in a distributed manner.

Unless defined otherwise, all terms used herein including technical or scientific terms may include the same meaning as those generally understood by persons skilled in the art to which the present invention belongs. Terms as defined in dictionaries generally used should be construed as including meanings which accord with the contextual meanings of related technology. Also, unless clearly defined in this disclosure, the terms should not be construed as having ideal or excessively formal meanings.

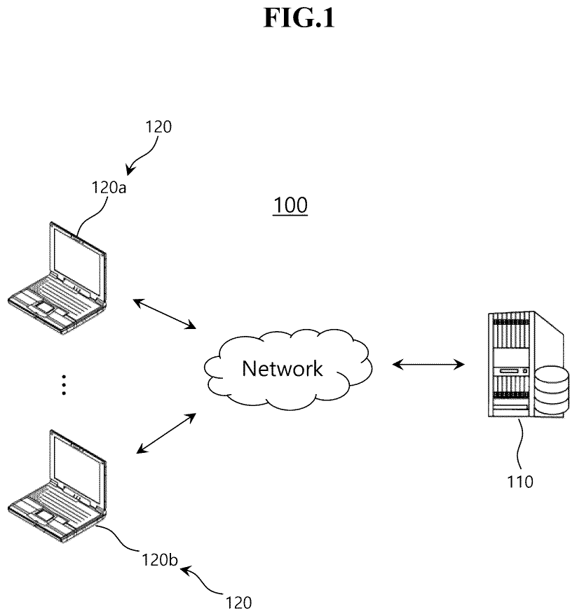

FIG. 1 is a view illustrating a hierarchical project management system according to an embodiment of the present invention.

Referring to FIG. 1, a hierarchical project management system 100 may include a hierarchical project management apparatus 110 and a user terminal 120, which may be connected through a network.

The hierarchical project management apparatus 110 may correspond to a computing apparatus connected to the user terminal 120 and capable of performing hierarchical project management. In one embodiment, the hierarchical project management apparatus 110 may manage at least one group of members including users associated with the user terminal 120 as members, and may manage a message thread that group messages transmitted in member groups established through at least one user terminal 120. In one embodiment, the message thread may be implemented in a chat room of the Internet messenger. In another embodiment, the message thread may be implemented through posts of an online bulletin board.

In one embodiment, the hierarchical project management apparatus 110 may be connected to the user terminal 120 via a project management messaging agent installed in the user terminal 120. In one embodiment, when installed in the user terminal 120, the project management messaging agent may be an agent program that is software that allows the user terminal 120 and the hierarchical project management apparatus 110 to be connected with each other through a network and to interact with each other under the approval of the user terminal 120.

The user terminal 120 may correspond to a computing device connected to the hierarchical project management apparatus 110. For example, the user terminal 120 may be implemented as a desktop, a notebook, a tablet PC or a smart phone. In one embodiment, the first user terminal 120a may correspond to a mobile terminal, and may be connected to the hierarchical project management apparatus 110 through cellular communication or Wi-Fi communication. In another embodiment, a second user terminal 120b may correspond to a desktop, and may be connected to the hierarchical project management apparatus 110 via the Internet.

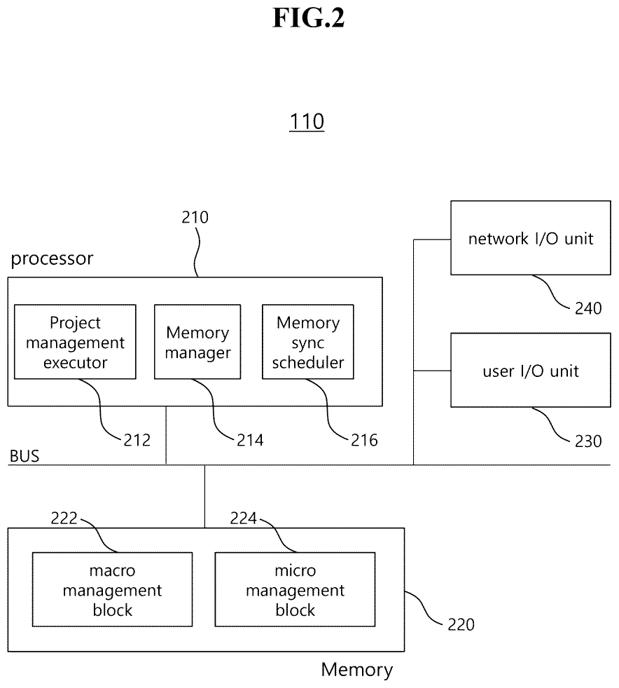

FIG. 2 is a view illustrating a hierarchical project management apparatus of FIG. 1.

Referring to FIG. 2, the hierarchical project management apparatus 110 may include a processor 210, a memory 220, a user input/output unit 230, and a network input/output unit 240.

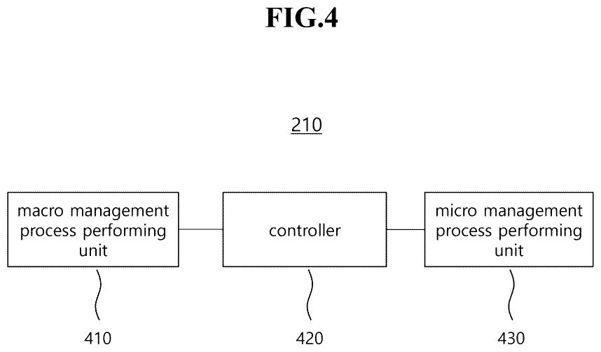

The processor 210 may include a project management executor 212 that can execute the hierarchical project management procedure shown in FIG. 4, a memory manager 214 that can manage macro and micro management blocks 222 and 224 in the memory 220 that is read or written by the project management executor 212, and a memory sync scheduler 216 that can schedule the synchronization time between the volatile memory and the non-volatile memory in the memory 220. The processor 210 may control the overall operation of the hierarchical project management apparatus 110, and may control the data flow among the memory 220, the user input/output unit 230, and the network input/output unit 240. The processor 210 may be implemented as a Central Processing Unit (CPU) of the hierarchical project management apparatus 110.

The memory 220 may include an auxiliary storage device that is implemented with a non-volatile memory such as a Solid State Disk (SSD) or a Hard Disk Drive (HDD), and a main storage device that is implemented with a volatile memory such as a Random Access Memory (RAM). As such, the memory 220 may be implemented with volatile and non-volatile memories, and may be implemented to be connected through a hyperlink when implemented with a non-volatile memory.

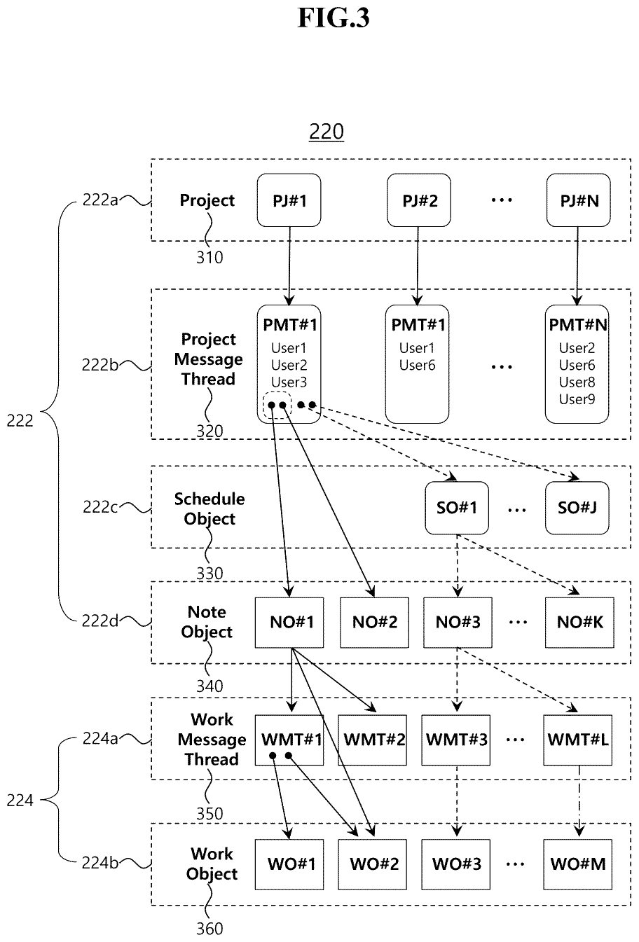

The memory 220 may include a macro management block 222 and a micro management block 224. This will be described in more detail with reference to FIG. 3.

FIG. 3 is a view illustrating a data structure of a memory in FIG. 2.

The memory 220 may store the macro management block 222 and the micro management block 224 which have different work evaluation access rights. In one embodiment, the work evaluation access right may correspond to an access right that is stored in the corresponding management block (macro management block 222 or micro management block 224) and is capable of reading/writing work evaluation data for work evaluation, and may be stored in association with the corresponding user information when assigned to at least one specific user.

The macro management block 222 may include a project management block 222a, a project message thread management block 222b, a schedule object management block 222c, and a note object management block 222d. A project 310 may be stored in the project management block 222a. A project message thread 320 uniquely associated with the specific project 310 may be stored in the project message thread management block 222b. The schedule object management block 222c may store at least one schedule object 330 that may be associated with the specific project message thread 320 in a one-to-many relationship. The note object management block 222d may store at least one note object 340 that may be associated with the project message thread 320 or the schedule object 330 in a one-to-many relationship. In one embodiment, the macro management block 222 further include a multimedia file object management block (not shown) and an attachment file management block (not shown) that store at least one multimedia file object and attachment file object associated with the project message thread 320, respectively.

For example, a project PJ #1 stored in the project management block 222a may be associated in a one-to-one relationship with the project message thread PMT #1 uniquely generated according to the generation of the corresponding project. The project message thread PMT #1 stored in the project message thread management block 222b and accessible through the project management block 222a may be associated in a one-to-many relationship with a plurality of note objects NO #1 and NO #2 and a plurality of schedule objects SO #1, . . . , SO #J. The schedule object SO #1 stored in the schedule object management block 222c and accessible through the project message thread management block 222b may be associated in a one-to-many relationship with a plurality of note objects NO #3, . . . , NO #K. The note object NO #1 stored in the note object management block 222d and accessible through the project message thread management block 222b or the schedule object management block 222c may be associated in a one-to-many relationship with a plurality of work message threads WMT #1 and WMT #2 and a work object WO #2. (In FIGS. 3, N, J, K, L, and M may be natural numbers and may have the same or different values)

The micro management block 224 may include a work message thread management block 224a and a work object management block 224b. The work message thread management block 224a may store at least one work message thread 350 associated with the note object 340, the multimedia file object, or the attachment file object. The work object management block 224b may store at least one work object 360 associated with the note object 340 or the work message thread 350. For example, a work message thread WMT #1 stored in the work message thread management block 224a, associated with the note object 340 or the schedule object 330 and accessible through the note object management block 222d may be associated with a plurality of work objects WO #1, WO #2, . . . , WO #M in a one-to-many relationship. The plurality of work objects WO #1, WO #2, . . . , WO #M may be stored in the work object management block 224b, and may be accessed through the work message thread management block 224a.

The memory 220 may further include a user memory block in which user information associated with the user terminal 120 is stored. Here, the user information may include at least one of a user's name (on-line ID), a messenger ID, a password, an affiliated member group, a participating project, and work evaluation point information.

The user input/output unit 230 may include an environment for receiving a user input and an environment for outputting specific information (e.g., project evaluation data) to a user. For example, the user input/output unit 230 may include an input device including an adapter such as a mouse, a trackball, a touchpad, a graphic tablet, a scanner, a touch screen, a keyboard or a pointing device, and an output device including an adapter such as a monitor or touch screen. In one embodiment, the user input/output unit 230 may correspond to a computing device connected via a remote connection. In this case, the hierarchical project management apparatus 110 may serve as a server.

The network input/output unit 240 may include an environment for connecting with the user terminal 120 through a network. For example, the network input/output unit 240 may include an adapter for Local Area Network (LAN) communication.

FIG. 4 is a view illustrating functional elements of a processor in FIG. 2.

Referring to FIG. 4, the processor 210 may include a macro management process performing unit 410, a controller 420, and a micro management process performing unit 430.

The processor 210 may control the tree structure association between the macro management block 222 and the micro management block 224. As described above, the macro management block 222 and the micro management block 224 may have a tree structure in which the macro management block 222 and the micro management block 224 can be associated with each other in a one-to-many relationship. The processor 210 may control the association between the macro management block 222 and the micro management block 224. In one embodiment, the processor 210 may update the tree structure between the macro management block 222 and the micro management block 224 when the creation or deletion of the associated work object 360 occurs in regard to the specific project 310. For example, when the work object WO #2 associated with the note object NO #1 is deleted, the processor 210 may disconnect the connection between the note object NO #1 in the macro management block 222 and the work object WO #1 in the micro management block 224, and may update the tree structure between the macro management block 222 and the micro management block 224.

The macro management process performing unit 410 may perform a macro management process. In one embodiment, the macro management process may be a macroscopic management process performed for efficient project progress. The macro management process may include at least one of a data management process including creation, modification and deletion of at least one of the project 310, the project message thread 320, the schedule object 330 and the note object 340 associated with the macro management block 222, a progress management process including pressing project participants for project-related progress, reminding, and provision of related information in order to increase the efficiency of the project progress, and an evaluation management process including an evaluation on the overall project.

More specifically, the macro management process performing unit 410 may perform the following macro management processes.

The macro management process performing unit 410 may generate the project 310 and the project message thread 320 associated with the project 310 in the macro management block 222. In one embodiment, the macro management process performing unit 410 may generate the specific project 310 and the project message thread 320 associated with the specific project 310 in a one-to-one relationship through the user's project creation right, and may store the specific project 310 and the project message thread 320 in the macro management block 222, respectively. Here, the project creation right may be granted to at least one user, or may be granted to a super manager and at least one sub-manager (e.g., team leader) designated by the super manager.

In one embodiment, the macro management process performing unit 410 may grant a work performance access right for the macro and micro management blocks 222 and 224 associated with the corresponding project 310 to at least one user participating in the project message thread 320. For example, the macro management process performing unit 410 may grant a user who is participating in the project message thread 320 implemented in a project chat room of a messenger a work performance access right to participate in the process of the corresponding project 310. When the corresponding user leaves the corresponding project chat room, the macro management process performing unit 410 may perform reset such that the corresponding work performance access right is not granted to the corresponding user. The macro and micro management process performing units 410 and 430 may generate at least one note object 340 or schedule object 330 associated with the corresponding project message thread 320 through the work performance access right of a user, or may perform a data management process according to the user work performance for generating a work object 360 associated with the note object 340 that is already generated.

The macro management process performing unit 410 may associate the note object 340 with the project message thread 320. In one embodiment, the macro management process performing unit 410 may receive a new note object creation request related to the corresponding project 310 from the user terminal 120 through a project message thread interface 710 that visualizes the project message thread 320 in a project management messaging agent (e.g., a project management messenger) installed in the user terminal 120. The macro management process performing unit 410 may generate a note object 340 including at least one of a note name, a note content, a note creator, and a note participant (at least one user designated as a main participant in regard to the corresponding note content by the note creator) based on the note information received from the user terminal 120, and may associate the note object 340 with the corresponding project message thread 320.

Here, the note object 340 may include a container of the work object 360 as a unit work of the corresponding project 310. For example, the note object 340 may correspond to a parent node of the corresponding work object 360 associated in a one-to-many relationship with work objects 360 generated through itself or the work message thread 360 associated with itself.

The macro management process performing unit 410 may generate the corresponding note object 340 by adding the note object 340 to the corresponding project message thread 320 as an independent note message that can be directly accessed in the corresponding project message thread 320 and distinguished from a text message or a media message. For example, each of the note objects 340 may be accessed as a note message by members participating in the chat room in the project message thread 320 implemented in the chat room of the messenger. The note object 340 may correspond to a note message object that is distinguished from a conversation message corresponding to a general text message and a media message such as a photograph or a video message.

In one embodiment, the macro management process performing unit 410 may determine the importance of the project 310 based on the number of generated note objects 340 associated with the project message thread 320, and may provide information on the corresponding importance to the super manager. For example, the macro management process performing unit 410 may determine the importance of the project 310 as one of ‘high’, ‘middle’, and ‘low’ in accordance with whether the number of generated note objects 340 is within a first reference range, a second reference range, or a third reference range. The macro management process performing unit 410 may provide the determined importance information to the user terminal 120 to emphasize and visualize a specific project 310 having a high importance or to preferentially display a project list associated with the corresponding user.

When the number of generated note objects 340 associated with a specific project message thread 320 or the update frequency of the corresponding work message thread 350 is equal to or smaller than a specific reference, the macro management process performing unit 410 may provide a note object creation recommendation message that recommends the creation of a new note object associated with the corresponding project message thread 320 through the corresponding project message thread 320. For example, when the number of records of the related note object 340 is insufficient in regard to the specific project 310, the macro management process performing unit 410 may provide information on the current creation number of the note objects 340 recommended to be generated in the corresponding project message thread 320 with respect to the reference number, thereby adding a note object creation recommendation message for encouraging the note record.

In one embodiment, the macro management process performing unit 410 may reflect the reference number of the note objects 340 designated from the project creator in proportion to the period from the project creation date in order to determine whether to provide the note object creation recommendation message.

In one embodiment, the macro management process performing unit 410 may determine whether or not to provide a note object generation recommendation message for the corresponding project 310 based on Equation (1) below in consideration of the number of the note objects 340 associated with the specific project message thread 320 and the last message processing time of the corresponding work message thread 350. For example, in the case where nₛ is set to 5 in regard to a specific project 310 (nₛ=5), when the creation number of associated note objects 340 is 3 (n=3) and the last message update time point of two work message threads 350 associated with the corresponding note object 340 is 72 hours ago and 50 hours ago, respectively (m_{avg}=61), the macro management process performing unit 410 may calculate a note object creation recommendation message determination index d into 1.22 to determine the provision of the note creation recommendation message (Here, it may determined that the note creation recommendation message is provided only when the corresponding determination index d is greater than or equal to 1).

$$d = \frac{( {n}_{s} - n ) \times {m}_{avg}}{100} \qquad ( 1 )$$

Here, nₛ may correspond to the reference number of note object creation recommended for the project 310, and may be set and adjusted by the super manager or sub-manager. Also, n denotes the number of note objects 340 associated with the corresponding project message thread 320, and m_{avg} denotes the average value of the last message processing time of the associated work message thread 350.

In one embodiment, the macro management process performing unit 410 may receive a note object creation recommendation response message associated with an instantaneous generation of a new note object or a reservation for a new note object creation after a specific time as a response to the note object creation recommendation message. In one embodiment, the note object creation recommendation response message may include a specific time and a temporary note name designated by a responder that performed the corresponding response. If the received note object creation recommendation response message is associated with the reservation for creating a new note object after a specific time, the macro management process performing unit 410 may include the corresponding responder as the note creator when time reaches the specific time. The macro management process performing unit 410 may generate a note object 340 including the corresponding temporary note name, and may automatically add the note object 340 to the corresponding work message thread 350 as a note message. The macro management process performing unit 410 may further provide a note creation completion urging message to the corresponding note creator to urge completion of creation of the note object 340. In one embodiment, when a separate user is designated as a reservation note finisher by the responder, the right to modify the corresponding note object 340 may be granted to the corresponding user.

In one embodiment, when the sum of the reservation points of the work object 360 dependent on the specific note object 340 is greater than or equal to a specific reference, the macro management process performing unit 410 may set the corresponding note object 340 as the main note activity of the corresponding project 310. For example, the macro management process performing unit 410 may inform of the corresponding setting through the corresponding project message thread 320. The macro management process performing unit 410 may provide the setting information to the user terminal 120 to allow the user terminal 120 to perform a visual indication emphasizing the main note activity. Here, the reservation point means a maximum target point which is included in the work object 360 and is the maximum upper limit of the point that can be evaluated in regard to the work object 360 through the work creator, and a detailed description thereof will be made in the description about the work object 360.

The macro management process performing unit 410 may associate at least one schedule object 330 having a schedule timeline defined through the start date and the finish date with the generated project message thread 320. In one embodiment, the macro management process performing unit 410 may receive a new note object creation request related to the corresponding project 310 from the user terminal 120 through the project message thread interface 710 of the project management messaging agent installed in the user terminal 120. The macro management process performing unit 410 may generate a schedule object 330 including a schedule content, a schedule timeline, and a schedule target based on the schedule information received from the user terminal 120, and may add the schedule object 330 to the corresponding project message thread 320. In one embodiment, the schedule target may include a target value and a current achieved value that may be quantitatively or qualitatively inputted by a user. The macro management process performing unit 410 may approximately determine the completion of the target and the proximity of the target by comparing the target value with the latest updated current achieved value.

In the schedule object 330, a recipient of the schedule may be designated by the schedule creator, and all or at least one of the participants participating in the project message thread 320 associated with a specific project 310 may be designated as the recipient of the schedule.

In one embodiment, the schedule object 330 may have a schedule point defined in units of the corresponding sub-work. For example, the schedule object 330 may be quantitatively and automatically calculated on the basis of a work point of the work object 360 generated through the note object 340 associated with the corresponding schedule object 330. In another embodiment, the schedule object 330 may be qualitatively evaluated by a work creator or a super manager, and may also have a schedule point with an upper limit of the evaluation point.

The macro management process performing unit 410 may re-associate the tree structure between the macro management block 222 and the micro management block 224 when the creation or deletion of the note object 340 associated with the project message thread 320 or associated with the schedule object 330 occurs.

In one embodiment, the macro management process performing unit 410 may generate schedule achievement information analyzed in time series about the corresponding schedule object 330 based on the start date and the finish date in the schedule timeline of the schedule object 330. More specifically, the macro management process performing unit 410 may detect at least one of the number of generated notes 340 in association with the corresponding schedule object 330 during at least one time interval divided in time series between the start date and the finish date, a message processing amount of the note message thread 350 associated with the corresponding note message thread 340, and the number of generated work objects 360 and the number of processed work objects 360 through the corresponding note message thread 350 to generate as the schedule achievement information during the corresponding time interval.

In one embodiment, the macro management process performing unit 410 may analyze the number of registrations and the project association in regard to at least one of the note object 340, the multimedia file object, and the attachment file associated with the project message thread 320, thereby generating project achievement information that is analyzed in time series. The macro management process performing unit 410 may also generate the synthetically analyzed achievement information on each of the projects 310.

In one embodiment, the macro management process performing unit 410 may calculate the project association based on the number of views through direct access in regard to each of the note object 340, the schedule object 330, the multimedia file object, and the attached file which are added to the project message thread 320. For example, the macro management process performing unit 410 may calculate the number of views with respect to the project participants into the project association for each. In another embodiment, the macro management process performing unit 410 may also calculate the project association of the corresponding note object 340 based on the number of generated work objects 360 with respect to a preset reference number for each of the note objects 340.

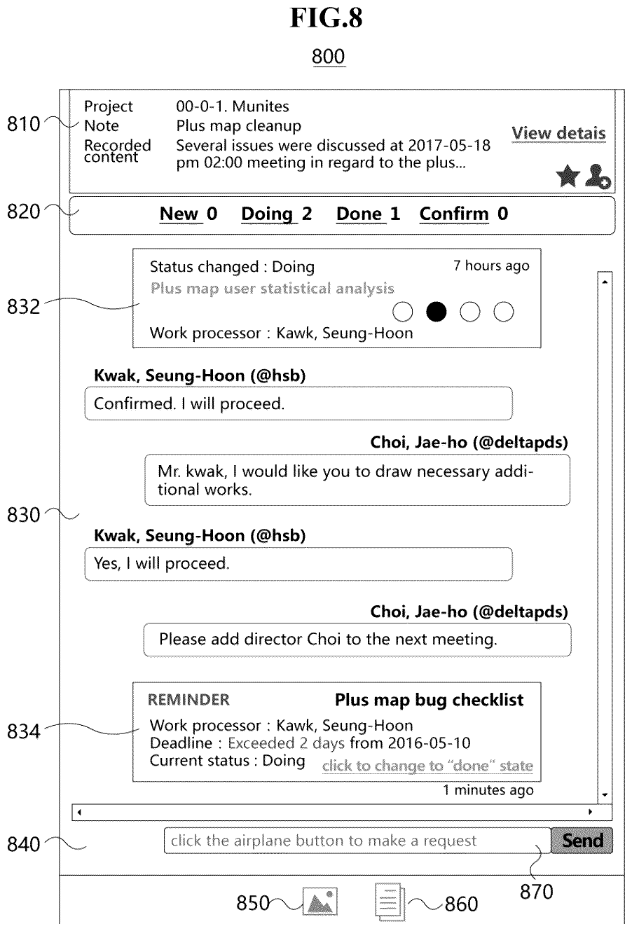

The macro management process performing unit 410 may determine the current schedule progress state based on the start date and the finish date in a schedule deadline of the schedule object 330. The macro management process performing unit 410 may provide update information on the corresponding schedule object 330 through the corresponding project message thread 320 whenever the schedule progress state, thereby improving the project progress efficiency. In one embodiment, the macro management process performing unit 410 may indicate the schedule progress state of the corresponding schedule object 330 through the progress state for each process step of at least one schedule object 330. For example, the schedule progress state of the schedule object 330 may include ‘closed’, ‘past’, ‘in progress’, and ‘scheduled’. Herein, ‘scheduled’ means a schedule state before the start date of the corresponding schedule object 330, and ‘in progress’ means a schedule state capable of generating the associated note 340 as a currently progressing state. ‘past’ means a schedule state in which the finish date of the corresponding schedule object 330 has passed and the associated note 340 is not generated and evaluation needs to be performed. Also, ‘closed’ means a schedule state in which the finish date passed and the evaluation was also completed (See FIG. 8).

In one embodiment, when the number of generated notes 340 associated with each schedule object 330 or the update frequency of the corresponding note message thread 350 is equal to or smaller than a specific reference, the macro management process performing unit 410 may provide a note creation recommendation message that recommends the creation of a new note associated with the corresponding schedule object 330 through the corresponding project message thread 320.

In one embodiment, when the number of notes 340 associated with each schedule object 330 or the update frequency of the corresponding note message thread 350 is smaller than or equal to a specific reference and the schedule target associated with the schedule object 330 is achieved over a specific percentage, the macro management process performing unit 410 may provide a schedule completion recommendation message recommending the completion of the corresponding schedule object 330 instead of the note creation recommendation message. In the above description, the specific reference or the specific percentage may be set and adjusted by the super manager.

In one embodiment, the macro management process performing unit 410 may determine the state of the corresponding schedule object 330 as one of a scheduled state, a progress state, a termination state and an evaluation completion state based on the schedule deadline of each of at least one schedule object 330. In one embodiment, even in regard to the schedule object 330 that is determined as the progress state, when a termination treatment request about the corresponding schedule object 330 from the user terminal 120 associated with the super manage or sub-manager, the macro management process performing unit 410 may determine that the corresponding schedule object 330 is terminated earlier than the finish date, and may process the state of the schedule object 330 into the termination state.

In one embodiment, the macro management process performing unit 410 may adjust the schedule timeline of the second schedule object based on a difference between the finish date and the completion date when the first schedule object is completed, by associating schedule timelines of the first and second schedule objects designated by the super manager among at least one schedule object 330 with each other. For example, when the first schedule object is completed earlier than the finish date, the macro management process performing unit 410 may advance the start date and the finish date in the schedule timeline of the second schedule object by the corresponding difference. When the first schedule object is completed later than the finish date, the macro management process performing unit 410 may adjust the start date and the finish date so as to be delayed by the corresponding difference.

In one embodiment, the macro management process performing unit 410 may reflect the difference between the finish date and the completion date in the schedule evaluation of the corresponding schedule object 330. For example, the macro management process performing unit 410 may add a percentage (e.g., about 10%) corresponding to a specific number of days to the schedule point of the schedule object 330 that is completed earlier than the corresponding finish date by a specific number of days (e.g., about 5 days).

The macro management process performing unit 410 may evaluate the project 310 through the work evaluation access right of the super manager. In one embodiment, the macro management process performing unit 410 may associate each of at least one user participating in the project message thread 320 with a practitioner or observer of the corresponding project 310. In addition, the macro management process performing unit 410 may grant a project creator or a specific observer designated by the corresponding project creator a work evaluation access right as a super manager for evaluating the corresponding project 310. For example, one of the users designated as the observer may be designated as the super manager corresponding to the evaluator of the project 310, and the work evaluation access right of the super manager may be granted to the corresponding evaluator. In addition, one of the practitioners designated as team members may be designated as a team leader as a sub-manager. The super manager may evaluate the project 310 as an evaluator, and may allow the sub manager as an evaluatee to grant the project evaluation point about the performance of the project 310.

In one embodiment, the macro management process performing unit 410 may grant a qualitative project evaluation point of the corresponding project 310 based on the evaluation of the corresponding project 310 received from the user terminal 120 associated with the super manager. For example, in the process of performing the evaluation, the macro management process performing unit 410 may receive, from the super manager, a project evaluation point in which the project evaluation maximum point predetermined by the project creator is an upper limit.

In one embodiment, the macro management process performing unit 410 may calculate a quantitative project evaluation point of the corresponding project 310 based on the number of generated note objects 340 associated with the corresponding project 310, the number of generated work objects generated through the corresponding note object 340, the processing number, and the process period.

In one embodiment, the macro management process performing unit 410 may calculate a total evaluation point of the project 310 based on the qualitative project evaluation point and the quantitative project evaluation point about the project 310. The macro management process performing unit 410 may calculate the comprehensive evaluation point of the project 310 by summing or averaging the qualitative project evaluation points and the quantitative project evaluation points, or by performing operation processing according to the weighted values. When the comprehensive evaluation point about the corresponding project 310 is calculated, the macro management process performing unit 410 may provide the comprehensive evaluation point to the user terminal 120 such that the team leader who is the leader of the project 310 or all of the project participants of the project 310 check the comprehensive evaluation point. In one embodiment, the macro management process performing unit 410 may also perform the process of calculating the comprehensive evaluation point by the predetermined objects 330.

In one embodiment, the macro management process performing unit 410 may update the quantitative project evaluation points at a specific period until the project 310 is terminated. The macro management process performing unit 410 may select a specific project activity for improving the updated quantitative project evaluation point, and may recommend the specific project activity through the corresponding project message thread 320. In one embodiment, the macro management process performing unit 410 may analyze the calculation standard of the quantitative project evaluation point. Thus, the macro management process performing unit 410 may determine, as the specific project activity, one of creation of a new note object 340, creation of a new work object 360 associated with the already-created note object 340, quick processing of the already-created work object 360, and the improvement of the processed message throughput in the corresponding project message thread 320. For example, the macro management process performing unit 410 may update the quantitative project evaluation point of the corresponding project 310 at a cycle of 24 hours until the project 310 is terminated or a qualitative project evaluation point by the super manager is received. The macro management process performing unit 410 may detect a specific activity value (e.g., one of (i) the number of generated note objects 340, (ii) the number of generated work objects 360 associated with each note object 340, (iii) the work progress state of the corresponding work object 360, and (iv) the amount of message processed in the corresponding project message thread 320) that does not satisfy the calculation standard of the quantitative project evaluation point in regard to the quantitative project evaluation point calculated until the present, and may select a specific project activity (e.g., one of (i) creation of a new note object 340, (ii) creation of a new work object 360 associated with an already-created note object 340, (iii) quick processing of already-created work objects 360, and (iv) increase of the amount of communication messages through the corresponding project message thread 320) as the specific program activity for improving the quantitative project evaluation point. The macro management process performing unit 410 may provide a project activity recommendation message for recommending the specific project activity through the corresponding project message thread 320.

In one embodiment, when the evaluation of the specific project 310 is completed, the macro management process performing unit 410 may automatically evaluate the work cooperativity of all participants participating in the project 310 based on the analysis of a schedule timeline defined in regard to all the associated schedule objects 330 and a schedule timeline actually completed. In one embodiment, the macro management process performing unit 410 may compare the evaluation result of the work cooperativity evaluated for each project 310 with the average result of overall work cooperativity. Thus, the macro management process performing unit 410 may calculate an exemplary work cooperativity with respect to an upper specific percentage ratio (e.g., 20%), and may provide the exemplary work cooperativity to the user terminal 120.

In one embodiment, when information about at least one of a note content in at least one note object 340 or a schedule content, a schedule timeline, and a schedule target in at least one schedule object 330 is modified, the execution unit 410 may add a notification message including the corresponding change information and an access link for accessing the corresponding note object 340 or the schedule object 330 to the corresponding project message thread 320. The macro management process performing unit 410 may inform the participants of a message whenever the schedule object 330 or the note object 340 in the project message thread 320 is updated.

In one embodiment, when a registration request regarding one of the specific note object 340, the schedule object 330, the multimedia file, and the attachment file that is not associated with the specific project message thread 320, the macro management process performing unit 410 may generate a specific note object 340, a multimedia file, or an attachment fine of the corresponding request. The macro management process performing unit 410 may generate a new project 310 and a project message thread 320 associated with the corresponding project 310, and may associate the corresponding project message thread 320 with the note object 340, the multimedia files or the attachment file of the corresponding request. The macro management process performing unit 410 may generate a tree structure between the macro management block 222 and the micro management block 224 according to the creation of the new project 310, and may control the association between the macro management block 222 and the micro management block 224.

In one embodiment, when a termination processing request for the corresponding project 310 is received by the project creator or the super manager through the corresponding project message thread 320, the macro management process performing unit 410 may terminate the corresponding project 310, and may limit the creation of a new note object 340 through the corresponding project message thread 320.

In one embodiment, when at least one of the multimedia file object and the attachment file that is dependently associated to the project message thread 320 is generated through the project message thread 320, the macro management process performing unit 410 may store the at least one in the macro management block 222. In addition, the macro management process performing unit 410 may add the at least one to the corresponding project message thread 320 as a media message or an attachment file message.

The controller 420 may control the overall operation of the processor 210, and may control the data flow between the macro management process performing unit 410 and the micro management process performing unit 430.

The micro management process performing unit 430 may perform a micro management process. The micro management process performing unit 430 may perform a micro management process. In one embodiment, the micro-management process may be a microscopic management process performed for the purpose of efficient work management, which may include at least one of a data management process including creation, modification, and deletion of at least one of a message thread 350 and a work object 360 associated with a micro management block 224 and dependent on a specific note object 340, a multimedia file object or an attachment file, a progress management process including urging of work-related progress to related members, reminding, and provision of related information to enhance the efficiency of work management of the work object 360, and an evaluation management process including an evaluation of the overall work including the work process object 360.

More specifically, the micro management process performing unit 430 may perform the following micro management processes.

The micro management process performing unit 430 may create a work message thread 350 associated with the note object 340 in the micro management block 224, and may associate the work object 360 with the work message thread 350. In one embodiment, when a request for creation of a new work message thread 350 associated with the note object 340, the micro management process performing unit 430 may check whether or not an already-created chat room associated with the corresponding note object 340 exists between the corresponding work creator and the work processor. If it is determined that there is a chat room, the micro management process performing unit 430 may associate the work object 360 created based on the work information received from the user terminal 120 with the work message thread 350 of the corresponding chat room. If it is determined that there is no message, the micro management process performing unit 430 may newly create a chat room between the corresponding work creator and the work processor associated with the corresponding note object 340, and may associate the chat room with the work message thread 350.

The micro management process performing unit 430 may update the corresponding tree structure by inserting the corresponding work object 360 into the micro management block 224 whenever the work object 360 is created. In one embodiment, the micro management process performing unit 430 may generate a work message thread 350 associated with a multimedia file object or an attachment file object transmitted by a user through a specific project message thread 320 based on a user request. The micro management process performing unit 430 may associate the work object 360 with the work message thread 350.

The micro management process performing unit 430 may generate a work object 360 that includes a work creator, a work processor and a work evaluation point and can be fed back by the work processor. More specifically, when the work object 360 is created, the micro management process performing unit 430 may generate a work message thread 350 between a work creator and a work processor associated with the corresponding note object 340, and may associate the work object 360 with the work message thread 350 as a message object. Here, the work creator may correspond to a user associated with the user terminal 120 requesting creation of the corresponding work. A work processor may correspond to a user designated as a target for processing the work by the work creator. The work evaluation point may include an evaluation reservation point indicating the maximum upper limit of the evaluation point that may be evaluated by the work creator when the work is completed, and an evaluation point indicating the actually evaluated point. Accordingly, in one embodiment, the work creator may instruct or evaluate the work to the work processor via the work object 360 represented with a work message in the chat room.

The micro management process performing unit 430 may perform the progress of the work object 360 including the work progress state indicating the progress state by the processing step. More specifically, the micro management process performing unit 430 may update a predetermined work progress state in the work processing diagram by reflecting a request by one of the work creator and the work processor and a response by the other. The micro management process performing unit 430 may perform the progress of the work object 360 in a manner of updating the associated work message thread 350. In one embodiment, the work progress state may include ‘new’, ‘doing’, ‘done’, and ‘confirm’. ‘new’ indicates a state in which the work object 360 is newly created, and ‘in progress’ indicates a state in which the work processor is processing the corresponding work object 360. ‘done’ indicates a state in which the work processor has completed the work object 360 and waits for interaction with the work completion from the work creator, and ‘confirm’ indicates that the work creator confirmed a completed work object 360 of the work processor.

The micro management process performing unit 430 may update the work progress state of the corresponding work object 360 through a work object related response implemented with a response relationship between the work creator and the work processor. In one embodiment, the micro management process performing unit 430 may receive a work related response from the user terminal 120 associated with the work creator or work processor via an control interface in regard to the work object 360 in the project management messaging agent. Here, the work object related response may correspond to a response regarding a work object that can be responded by the user terminal 120 associated with the work creator or work processor. In one embodiment, the work object related response may include at least one of a work confirmation response, a work completion response, and a work evaluation response depending on the current work processing state of the corresponding work object. For example, when a work interaction is received from a member corresponding to a work processor in regard to the work object 360 whose work progress state is ‘new’, the micro management process performing unit 430 may update the work progress state to ‘in progress’ state that is the next progress state. When receiving the work object related response, the micro management process performing unit 430 may determine the current work processing state, and may update the associated work message thread 350.

The micro management process performing unit 430 may perform the progress of the work object 360, and may finally evaluate the work object 360 through the work evaluation access right of the work creator. In one embodiment, the micro management process performing unit 430 may receive a work evaluation response that is one of the work object related responses from the user terminal 120 associated with the work object creator in regard to the work object 360 whose work progress state is ‘done’. In addition, the micro management process performing unit 430 may assign the work evaluation point included in the work evaluation response and designated by the work creator as the work evaluation point of the work object 360. In one embodiment, the micro management process performing unit 430 may grant a work evaluation access right as a work creator the corresponding work object 360 to a specific practitioner designated by the project creator who created the project 310 or a work creator that created the corresponding work object 360. In addition, the micro management process performing unit 430 may receive a work evaluation point for evaluating the work content of the work processor regarding the work object 360 from a user who is granted the work evaluation access right.

The micro management process performing unit 430 may provide a remind message associated with the work object 360 through the work message thread 350 and requesting the completion of the corresponding work progress state according to a specific repetition standard until the work progress state is completed. More specifically, the micro management process performing unit 430 may detect at least one work object 360 that satisfies a pre-set remind condition from a set of the work objects, and may generate a remind message associated with each of the detected work objects. In addition, the micro management process performing unit 430 may provide the generated remind message to the user terminal 120 associated with a user designated as the work processor in each work object 360 according to a specific repetition standard (e.g., transmission at a cycle of about 12 hours), and may store, in association with the corresponding work object 360, the number of times of provision counted whenever the remind message is provided. In one embodiment, the micro management process performing unit 430 may determine a specific repetition standard based on a work processing state and a work finish date of the work object 360, and may generate a remind message according to the corresponding standard.

The micro management process performing unit 430 may generate a remind message including the remind contents and the number of reminds regarding the remind work object in the remind work object set, and may provide the remind message to at least one of the work processor, the work creator, and the work referrer associated with the corresponding remind work object. Here, the remind contents may include summary information about at least one of the work creator, the work processor and work content, the work progress state and finish date regarding the corresponding work object 360, and the number of reminds indicates the number of times of remind. The micro management process performing unit 430 may cumulatively count the number of times of the remind operation for each remind work object, and calculate the number of times of the remind operation.

In one embodiment, the micro management process performing unit 430 may provide the remind message through the work message thread 350 associated with the corresponding work object 360. The micro management process performing unit 430 may provide the generated remind message to the associated work message thread 360 as a work message, or may provide a list including a work object access link and a work summary about the remind work object through a project management interface 600. In one embodiment, the micro management process performing unit 430 may change the work progress state of the corresponding work object 360 based on the response of the corresponding work processor to the remind message associated with the specific work object 360.

In one embodiment, the micro management process execution unit 430 may check whether or not the difference in days until the finish date according to the work progress state of the work object 360 satisfies a specific condition to determine a remind urgency. If it is determined to be urgent, the micro management process performing unit 430 may increase the frequency of providing the remind message of the corresponding work object 360.

The micro management process performing unit 430 may calculate the work response speed based on the number of times of provision of the remind message, and may include the work response speed in the corresponding work evaluation point. Here, the work response speed may indicate what remind message the work processor interacts with to change the work progress state of the work object 360. As the calculated work response speed is smaller, it may mean that the corresponding work processor more quickly interacts and processes the work. For example, if the work processor changes the work process state in response to the corresponding remind message after the remind message is provided twice, the work response speed regarding the corresponding work object 360 may be calculated as 2.

In one embodiment, the micro management process performing unit 430 may calculate the work response speed of the work processor for each work progress state in regard to each work object 360. The micro management process performing unit 430 may calculate an average work response speed of the corresponding work processor 360 in regard to all the work objects 360 associated therewith. The micro management process performing unit 430 may calculate the average work response speed by individual or team.

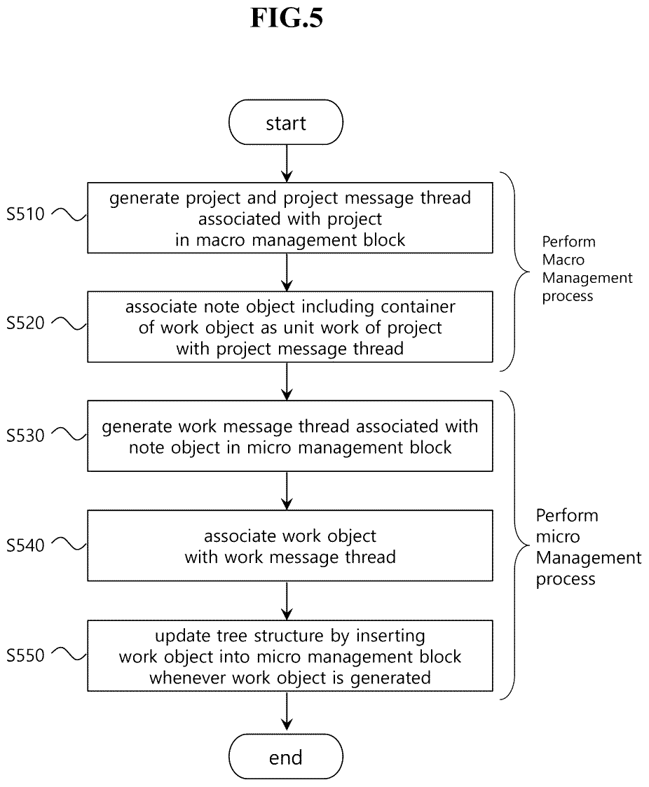

FIG. 5 is a flowchart illustrating a hierarchical project management procedure performed by a processor in FIG. 2.

Referring to FIG. 5, the macro management process performing unit 410 may generate the project 310 and the project message thread 320 associated with the project 310 in the macro management block 222. The macro management process performing unit 410 may perform a macro management process associating the note object 340 including the container of the work object 360 as a unit work of the corresponding project 310 with the project message thread 320. In one embodiment, the macro management process performing unit 410 may associate at least one schedule object 330 having a schedule timeline defined through the start date and the finish date with the project message thread 320. In this case, the note object 340 may be associated with the project message thread 320 or the schedule object 330.

The micro management process performing unit 430 may create a work message thread 350 associated with the note object 340 in the micro management block 224 (S530), and may associate the work object 360 with the work message thread 350 (S540). Also, the micro management process performing unit 430 may perform a micro management process of updating the corresponding tree structure (S550) by inserting the corresponding note object 340 into the micro management block 224 whenever the work object 360 is created (S520).

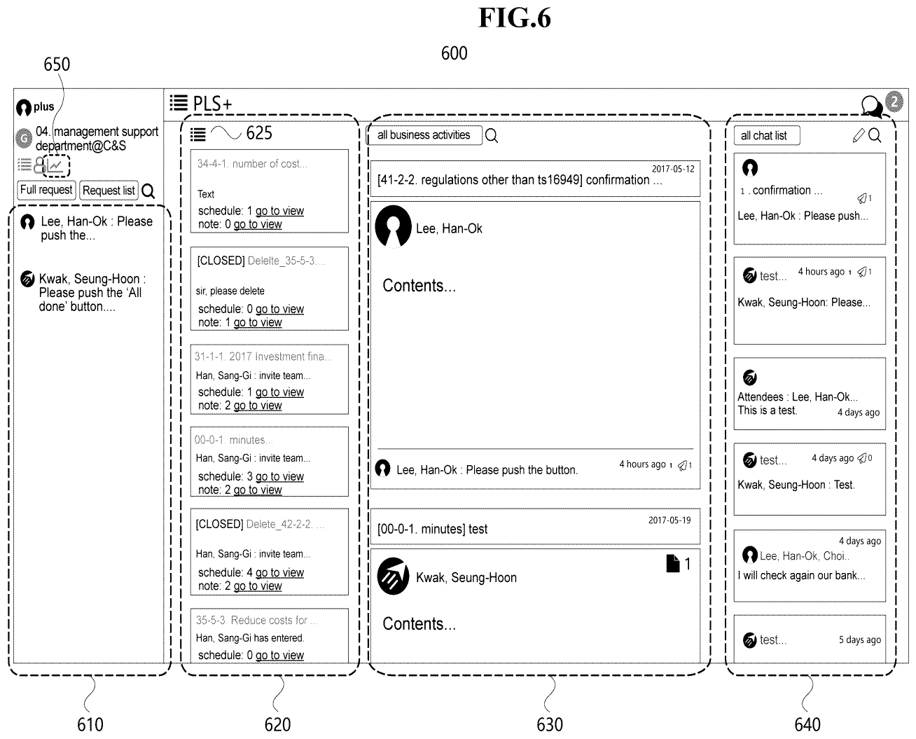

FIG. 6 is a view illustrating a process of providing hierarchical project management data by a hierarchical project management apparatus of FIG. 1 according to an embodiment of the present invention.

In FIG. 6, the hierarchical project management apparatus 110 may provide, to the user terminal 120, hierarchical project management data including macro management data stored in the macro management block 222 and being a result of performing the macro management process regarding a project 310 associated with a user, a project message thread 320, a schedule object 330, and a note object 340, and the micro management data stored in the micro management block 224 and being a result of performing the micro management process regarding the work message thread 350 and the work object 360. Thus, the hierarchical project management apparatus 110 may allow the user terminal 120 to display the corresponding macro management data and micro management data through the project management interface 600 in the project management messaging agent installed in the user terminal 120. In addition, the hierarchical project management apparatus 110 may receive a project management request associated with a user through the project management interface 600, and may perform a macro management process or a micro management process.

The user terminal 120 may visualize the hierarchical project management data provided from the hierarchical project management apparatus 110 through a today work provision area 610. Accordingly, a user may confirm a list of the work objects 360 that are associated with him/her or need to be reminded, or may confirm the corresponding remind message through the today work provision area 610.

Based on the hierarchical project management data provided from the hierarchical project management apparatus 110, the user terminal 120 may visualize a project message thread list including the project name, the number of associated schedule objects 330, the number of associated note objects 340, and the access link in regard to each project message thread 320 in which a user is participating through a project chat room provision area 620.

Based on the hierarchical project management data provided from the hierarchical project management apparatus 110, the user terminal 120 may visualize a note list including the note name, the note content, the creation information of the associated work object 360 and the access link of the note object 340 associated with the project message thread 320 in which a user is participating through a note provision area 630.

Based on the hierarchical project management data provided from the hierarchical project management apparatus 110, the user terminal 120 may visualize information on the work content and work progress state of the work object 360 with which a user is associated as a work creator or a work processor or information on the work message thread 350 with which a user is associated as a chatting participant.

Based on the hierarchical project management data provided from the hierarchical project management apparatus 110, the user terminal 120 may provide an interface that can visualize all the projects 310 and note objects 340 associated with a user through an all project view button 625.

As described above, the hierarchical project management apparatus 110 may provide the macro management data to the user terminal 120, and may support such that macroscopic topics such as project directivity are discussed through the project chat room provision area 620 and the note provision area 630. Also, the hierarchical project management apparatus 110 may provide a recommendation message that recommends prompting of activities by checking the number of associated note objects 340 or schedule objects 330 or the amount of processed messages. Also, the hierarchical project management apparatus 110 may perform a macro management process such as updating the corresponding project message thread 320 when associated note object 340 or schedule object 330 is newly created.

As described above, the hierarchical project management apparatus 110 may provide the micro management data to the user terminal 120, and may support such that microscopic topics regarding the work object 360 as a project unit work are discussed through a work message thread provision area 640. In addition, the hierarchical project management apparatus 110 may provide a notification message through the corresponding work message thread 350 when the work object 360 is newly created or modified. When the work progress state of the work object 360 is updated, the hierarchical project management apparatus 110 may update the work message thread 350, and may provide a remind message through the work message thread 350 in regard the work object 360 that needs to be reminded. Thus, the hierarchical project management apparatus 110 may perform the micro management process as described above.

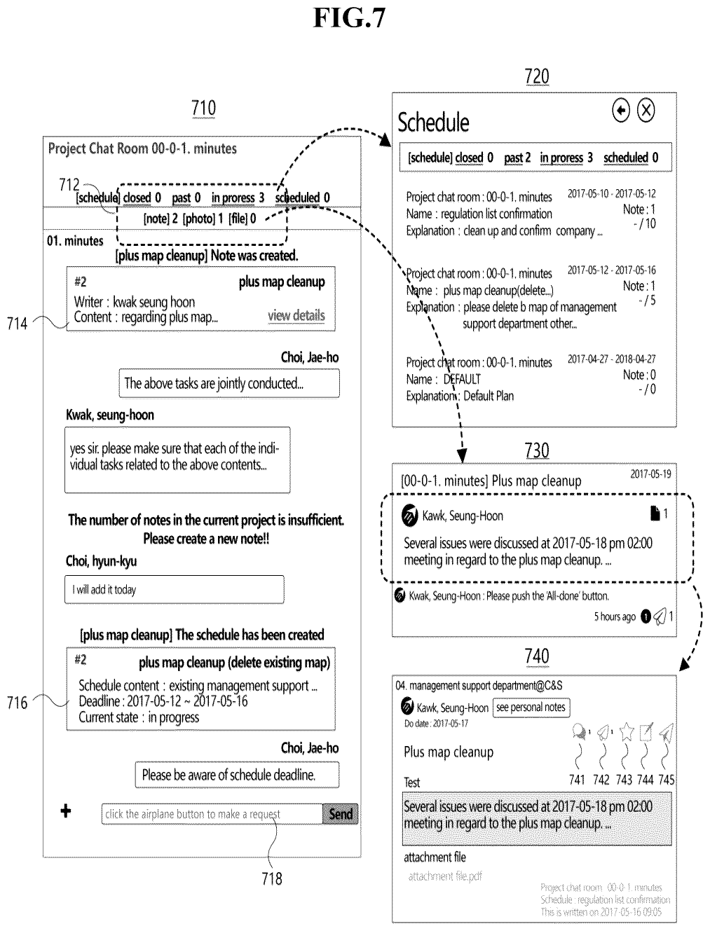

FIG. 7 is a view illustrating a process of performing a macro management process through a project message thread by a hierarchical project management apparatus in FIG. 1 according to an embodiment of the present invention.

In FIG. 7, the hierarchical project management apparatus 110 may provide the hierarchical project management data as a result of performing the macro and micro management processes to the user terminal 120 such that the user terminal 120 can display the result of performing the macro management process through the project message thread interface 710.

Based on the hierarchical project management data received from the hierarchical project management apparatus 110, the user terminal 120 may provide the association schedule and the creation number and access link of the associated schedule objects 330 for each schedule progress state through a note number provision area 712 (e.g., schedule of ‘closed’ state is 0, schedule of ‘past’ state is 0, schedule of ‘in progress’ state is 3, schedule of ‘schedule’ state is 0). The user terminal 120 may also provide the number and access link of notes 340 associated with the schedule object 330 or the project message thread 320, a multimedia file object (picture), an attachment file object (file).

Based on the hierarchical project management data received from the hierarchical project management apparatus 110, the user terminal 120 may visualize the associated note object 340 as a note message like an identification number 714. In addition, based on the hierarchical project management data received from the hierarchical project management apparatus 110, the user terminal 120 may visualize the associated schedule object 330 as a schedule message like the identification number 716. Also, the user terminal 120 may receive a conversation message between users through a conversation message input field 716, and may visualize the conversation message in the chat window.

When a user requests access to the associated specific schedule object 330 through a association schedule and note number provision area 712, the user terminal 120 may interact with the hierarchical project management apparatus 110, and may visualize a list of at least one associated schedule object 330 through a schedule object list interface 720 in linkage with the hierarchical project management apparatus 110. When access to the associated specific note object 340 is requested, the user terminal 120 may visualize a list of at least one associated schedule object 330 through the note object list interface 730.

When the specific note object 340 is selected from the visualized note object list through the note object list interface 730, the user terminal 120 may visualize information on note contents, note creator, note creation date, attachment file, and the like regarding the corresponding note object 340 through a note object control interface 740. The user terminal 120 may support the display of the creation number and the provision of the access link of the associated work message thread 350 through an opened chat room display icon 741. The user terminal 120 may support the display of the creation number and the provision of the access link of the associated work object 360 through an creation work object display icon 742. The user terminal 120 may receive a user request for setting the corresponding note object 340 as a main note object through a bookmark icon 743. The user terminal 120 may receive a user request for generating a new chat room associated with the corresponding note object 340 through a new chat room creation icon 744. The user terminal 120 may also receive a user request for creating a new work object 360 associated with the corresponding note object 340 through a new work object creation icon 745.

FIG. 8 is a view illustrating a process of performing a micro management process through a work message thread by a hierarchical project management apparatus in FIG. 1 according to an embodiment of the present invention.

The hierarchical project management apparatus 110 may provide the micro management data regarding the work message thread 350 and the work object 360 with which the user is associated as a project participant to the user terminal 120, and thus may visualize related information through a work message thread interface 800 in the corresponding project management messaging agent.

The work message thread interface 800 may include a main information display field 810, a work object progress state display field 820, a message display field 830, a work object creation button 840, a multimedia upload menu 850, a file upload menu 860, and a chat message input field 870.

The user terminal 120 may display at least one of note name, note content, and note creator included in the associated note object 340 through the main information display field 810. The user terminal 120 may display the number of generated work objects for each work progress state of the work object 360 generated through the work message thread 350 via the work object progress state display field 820. In addition, the user terminal 120 may support access to the corresponding work object 330 according to a user request.

The user terminal 120 may provide a work object 360 represented by a work message and a general chat message represented by a dialog message through the message display field 830. For example, in the case of work object 360, the user terminal 120, like the identification number 832, may visualize the corresponding work object 360 implemented with an independent work message that is distinguished from a general chat message or a multimedia file object, including the work content, work creator, and work processor, and including the work progress state that can be fed by the work processor (in FIG. 8, like new (●∘∘∘), in progress (∘●∘∘), done (∘∘●∘) or confirm (∘∘∘●) in regard to the work progress state, the current work progress states can be indicated through symbols corresponding to the current processing step). In addition, the user terminal 120, like the identification number 834, may provide a remind message including the main content of the work object 360 as a reminder target and a state change button (changeable from ‘doing’ state to ‘done’ state by work processor) that can change the current work progress state to the next state.

The user terminal 120 may be associated with the corresponding work message thread 350 through the work object creation button 840, and may receive a work object creation request including work information on the work creator, work processor, work content, and work evaluation point, and may transmit the request to the hierarchical project management apparatus 110. Accordingly, the hierarchical project management apparatus 110 may generate a work object 360 including a work creator, a work processor, a work content, and a work evaluation point based on the received work object creation request, and may add the work object 360 to the corresponding work message thread 350 as a work message. As a result, the user terminal 120 may visualize the work object 360 in a chat room as a work message, similarly to the identification number 832.

The user terminal 120 may receive an upload request for multimedia and files via the multimedia upload menu 850 and the file upload menu 860, respectively. The user terminal 120 may receive dialogues from a user through the chat message input field 870, and may transmit the dialogues to the hierarchical project management apparatus 110.

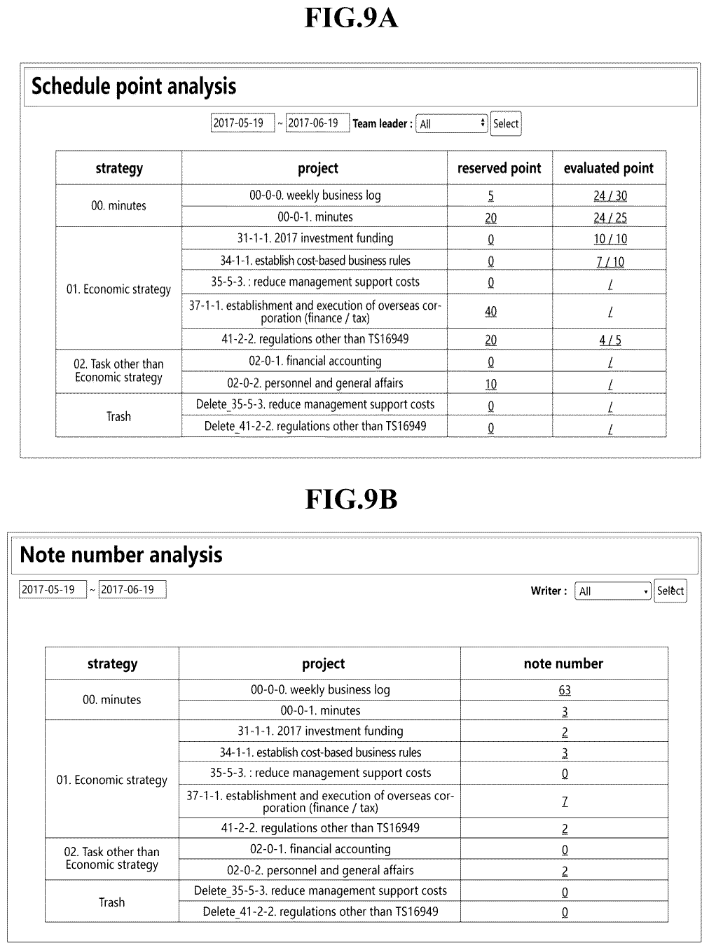

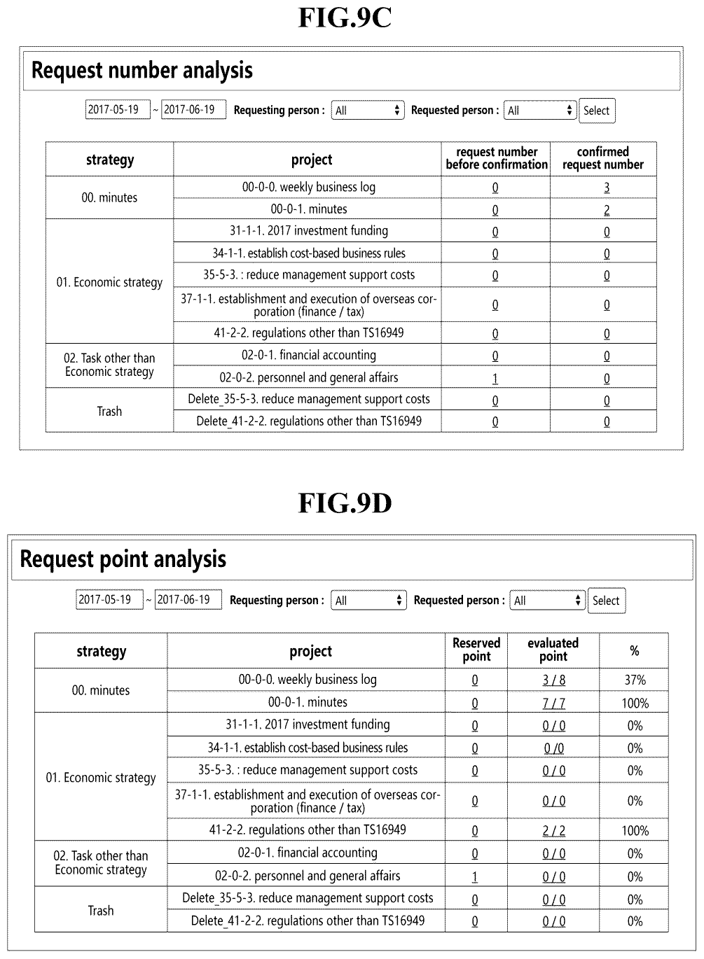

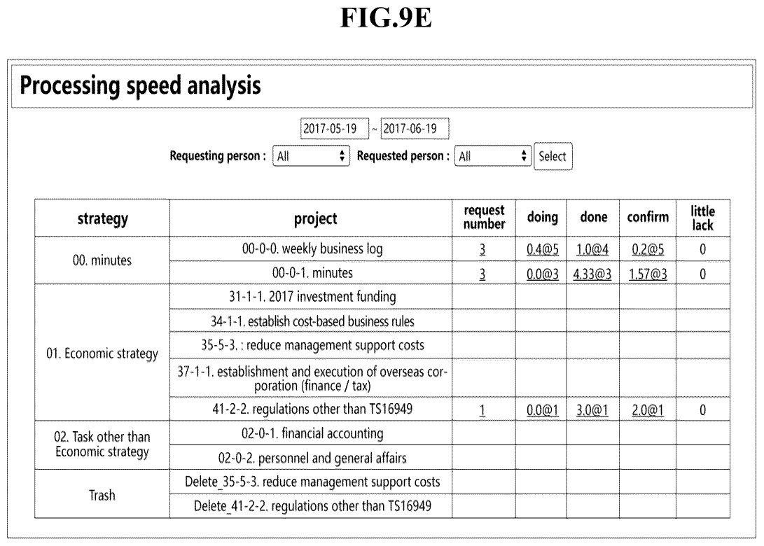

FIGS. 9A-9E are views illustrating a process of performing analysis according to a user request by a hierarchical project management apparatus of FIG. 1 according to an embodiment of the present invention.

The hierarchical project management apparatus 110 may receive an analysis request regarding all the schedule objects 330, the note objects 340 and the work object 360 associated with the project message thread 320 participated by a user through the analysis button 650 in the project chat room provision area 620. When the analysis request is received, the hierarchical project management apparatus 110 may perform analysis on the schedule object 330 or the note object 340 belonging to each project 310 and the work object 360 belonging to the corresponding note object 340. The hierarchical project management apparatus 110 may calculate the analyzed results for each project, and may provide the analyzed results to the user terminal 120.

In FIG. 9A, the hierarchical project management apparatus 110 may perform analysis on a schedule evaluation point of the associated schedule object 330 for each project 310 through a schedule analysis. The hierarchical project management apparatus 110 may provide the analysis result to the user terminal 120 such that the user terminal 120 can display a schedule point for each project 310 through a schedule point inquiry interface (FIG. 9A). When each point is selected, the hierarchical project management apparatus 110 may provide a list of the schedule objects 330 such that the list is displayed. Here, the reserved point indicates the sum of the points of the schedule object 330 in the ‘open’ state before the evaluation, and the evaluated point indicates the sum of the points of the schedule object 330 in the ‘closed’ state after the evaluation.

In FIG. 9B, the hierarchical project management apparatus 110 may perform analysis on the number of the associated note objects 340 for each project 310 through a note analysis. The hierarchical project management apparatus 110 may provide the analysis result to the user terminal 120 such that the user terminal 120 can display the number of notes for each project 310 through a note number analysis inquiry interface (FIG. 9B). When each point is selected, the hierarchical project management apparatus 110 may provide a list of the note objects 340 such that the list is displayed.

In FIG. 9C, the hierarchical project management apparatus 110 may perform analysis on the number of the associated work objects 360 for each project 310 through a work object analysis (analysis of the number of requests). The hierarchical project management apparatus 110 may provide the analysis result to the user terminal 120 such that the user terminal 120 can visualize the number of requests (work object 360) and reserved request points (reservation point of the work object 360) for each project 310 through a request number analysis inquiry interface (FIG. 9C). Here, the number of requests before confirmation means the number of work objects 360 in a state before being confirmed by the work processor.

In FIG. 9D, the hierarchical project management apparatus 110 may perform analysis on the work evaluation point of the associated work objects 360 for each project 310 through a work evaluation point analysis (request point analysis). The hierarchical project management apparatus 110 may provide the analysis result to the user terminal 120 such that the user terminal 120 can visualize the evaluated request point (work evaluation point of the work object 360) for each project 310 through a request number analysis inquiry interface (FIG. 9D).

In FIG. 9E, the hierarchical project management apparatus 110 may perform analysis on the work response speed of the associated work objects 360 for each project 310 through a work response speed analysis (processing speed analysis). The hierarchical project management apparatus 110 may provide the analysis result to the user terminal 120 such that the user terminal 120 can visualize the processed work response speed for each project 310 through a processing speed analysis inquiry interface (FIG. 9E).

The disclosed technology can have the following effects. However, since it is not meant to imply that a specific embodiment should include all of the following effects or include only the following effects, it should be understood that the scope of the disclosed technology is not to be construed as being limited thereby.

The hierarchical project management apparatus according to an exemplary embodiment of the present invention can improve the project management efficiency through hierarchical macro and micro management processes which are hierarchically performed.

The hierarchical project management apparatus according to an exemplary embodiment of the present invention can improve both the efficiency of the overall project and the efficiency of unit task management by performing a project-oriented macro management process through a project message thread and a unit task-oriented micro management process through a task message thread.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A hierarchical project management apparatus comprising:
a memory; and
a processor electrically connected to the memory,
wherein the processor
creates a project chatroom associated with a project,
creates at least one of a note object, a multimedia file object, and an attachment file associated with a work of the project in the project chatroom, and
creates a work object associated with the note object, the multimedia file object, or the attachment file, and including a work creator, a work processor, and a work progress state representing a progress state for each work processing step.

2. The hierarchical project management apparatus of claim 1, wherein the processor adds the note object to the project chatroom as an independent note message directly accessible in the project chatroom and distinguished from a text message or a media message to create the note object.

3. The hierarchical project management apparatus of claim 2, wherein the processor creates the note object including a note or a container of the work object associated with the note.

4. The hierarchical project management apparatus of claim 1, wherein when the number of created note objects associated with the project chatroom is equal to or less than a specific criterion, the processor provides a note object recommendation message that recommends creation of the associated new note object through the project chatroom.

5. The hierarchical project management apparatus of claim 4, wherein the processor determines whether to provide the note object recommendation message by reflecting a criterion number of note objects designated by a project creator to be proportional for each period from a project creation date.

6. The hierarchical project management apparatus of claim 1, wherein the processor analyzes a registration number and a project association for at least one of the note object, the multimedia file object, and the attachment file associated with the project chatroom to create project performance information analyzed in time series.

7. The hierarchical project management apparatus of claim 1, wherein the processor evaluates the project through a work evaluation access right of a super manager.

8. The hierarchical project management apparatus of claim 7, wherein the processor
grants a qualitative project evaluation point of the project based on an evaluation received from a user terminal associated with the super manager,
calculates a qualitative project evaluation point of the project based on the number of created note objects associated with the project, the number, the processing number and the processing period of work objects created through the note object, and
calculates a total evaluation point of the project based on the qualitative project evaluation point and the quantitative project evaluation point.

9. The hierarchical project management apparatus of claim 8, wherein the processor updates the quantitative project point at a specific period until the project ends, and selects a specific project activity for enhancing the quantitative project point and recommends the selected project activity through the project chatroom.

10. The hierarchical project management apparatus of claim 9, wherein the processor analyzes a calculation criterion of the quantitative project point to determine one of creation of a new note object, creation of a new work object associated with a pre-created note object, rapid processing of a pre-created work object, and enhancement of a message processing quantity processed in the project chatroom as the specific project activity.

11. The hierarchical project management apparatus of claim 1, wherein when note contents in at least one note object are modified, the processor adds a notification message including the change information and an access link for accessing the note object to the project chatroom.

12. The hierarchical project management apparatus of claim 11, wherein the processor notifies a message to participants whenever the note object in the project chatroom is updated.

13. The hierarchical project management apparatus of claim 1, wherein the processor
creates, when a registration request for a specific note object, a specific multimedia file, and a specific attachment file not associated with a specific project chatroom is received, the specific note object, multimedia file, or attachment file of the request, and
creates a new project and a project chatroom associated with the project to associate the note object, multimedia file, or attachment file of the request with the project chatroom.

14. The hierarchical project management apparatus of claim 1, wherein when at least one of a multimedia file object and an attachment file dependently associated with the project chatroom through the project chatroom is created, the processor adds the created one to the project chatroom as a media message or an attachment file message.

15. The hierarchical project management apparatus of claim 1, wherein when an analysis request for a note object and a work object associated with a project chatroom participated by a user is received, the processor performs an analysis for a note object belonging to each project and a work object belonging to the note object.

16. The hierarchical project management apparatus of claim 1, wherein the processor
performs a progress of the work object,
updates a work progress state of the work object through a work object related response implemented with a response relationship between the work creator and the work processor,
evaluates the work object through a work evaluation access right of the work creator, and
includes a work point which is a result of evaluating the work object in the work object.

17. The hierarchical project management apparatus of claim 1, wherein the processor provides a remind message that is associated with the work object through the project chatroom and requests completion of the work progress state according to a specific repetition criterion until the work progress state is completed.

18. The hierarchical project management apparatus of claim 17, wherein the processor calculates a work response speed based on the number of providing times of the provided remind message and includes the calculated response speed in a work point of the work object.
